(19) United States
(12) Patent Application Publication
(10) Pub. No.: US 2015/0056406 A1
(43) Pub. Date: Feb. 26, 2015

(54) ADHESIVE MICROSTRUCTURE

(71) Applicants: Technion R&D Foundation Ltd., Haifa (IL); Christian-Albrechts-Universitat zu Kiel, Kiel (DE)

(72) Inventors: Michael Varenberg, Haifa (IL); Stanislav Gorb, Kronshagen (DE)

(21) Appl. No.: 14/356,176

(22) PCT Filed: Nov. 8, 2012
(86) PCT No.: PCT/IL2012/050445

§ 371 Date: May 5, 2014

Related U.S. Application Data
(60) Provisional application No. 61/557,111, filed on Nov. 8, 2011.

(51) Int. Cl. C09J 7/00; B29C 39/02

(52) U.S. Cl. CPC C09J 7/00; B29C 39/026; B29L 2031/756
USPC 428/119; 264/299

(57) ABSTRACT

A microstructure made of flexible material includes a plurality of projections extending from a common substrate. A distal end of each projection includes a resilient flap. All lateral dimensions of each of the projections increase monotonically with increased distance from a surface defined by distal ends of the flaps when the flaps are unbent. Each of the projections extends from the common substrate in a general direction that is locally substantially perpendicular to the surface defined by the ends of the flaps. When a shear force is applied to each of the flaps by relative motion between the flap and a cooperating surface in contact with the flap, the flap bends so as to increase the area of contact of that flap with the cooperating surface, affecting adhesion between the microstructure and the cooperating surface.

### FIELD OF THE INVENTION

The present invention relates to adhesion. More particularly, the present invention relates to an adhesive microstructure.

### BACKGROUND OF THE INVENTION

In the process of evolution, nature has developed adhesive systems that are based on fine, spatula-shaped hair-like projections that project from limbs of some animals. By increasing van der Waals attraction between the limbs and the surface, the projections in these adhesive systems make it possible for many insects, spiders, and lizards (e.g., geckoes) to reversibly attach to and walk on a variety of surfaces, almost irrespective of the surface's orientation, geometry, or chemical composition. For example, some such animals have been observed to climb even smooth vertical surfaces and to walk along ceilings.

Reversible attachment, in which an object may attach to a surface, or may be detached from the surface using relatively little force, has many uses and applications in many fields of technology. Much effort has been made to mimic the known effective natural solutions to the problem.

Solutions to the problem of reversible attachment have been previously described. Some of the solutions are limited to attachment of one surface to another when one or both surfaces have been specially prepared or have particular properties. For example, solutions based on suction may be limited to attachment of objects to smooth non-porous surfaces, and only under conditions of sufficient ambient atmospheric or fluid pressure. Other solutions, such as hook-and-loop fasteners, may be limited to enabling reversible mechanical binding between surfaces that are appropriately prepared with (e.g., by attachment of strip that includes) either a hook structure or a corresponding loop structure. Other mechanical solutions, such as clips or hooks, may be appropriate for holding an object having an appropriate shape or structure (e.g., corresponding indentations or tabs). Magnets may be used for attachment to a ferromagnetic surface. Pressure sensitive adhesives may leave a residue on the surface or object after detachment, or may be limited to use for attachment to a surface having appropriate properties or under a limited set of ambient conditions (including, e.g., dryness, porosity, temperature, or chemical compatibility of the surface or environment).

Solutions have been described that are based on van der Waals adhesion. For example, in some described solutions, adhesive projections are provided that are inclined with respect to the object surface, are soft at their ends, or that are provided with widened ends (e.g., mushroom shaped) so as to increase the adhesion. Producing such surfaces may require application of nonstandard manufacturing techniques.

### SUMMARY OF THE INVENTION

There is thus provided, in accordance with some embodiments of the present invention, a microstructure made of flexible material and including a plurality of projections extending from a common substrate, a distal end of each projection including a resilient flap, wherein all lateral dimensions of each of the projections increase monotonically with increased distance from a surface defined by distal ends of the flaps when the flaps are unbent, and wherein each of the projections extends from the common substrate in a general direction that is locally substantially perpendicular to the surface defined by the ends of the flaps, such that when a shear force is applied to each of the flaps by relative motion between that flap and a cooperating surface in contact with that flap, that flap bends so as to increase the area of contact of that flap with the cooperating surface and to affect adhesion between the microstructure and the cooperating surface.

Furthermore, in accordance with some embodiments of the present invention, the surface defined by the ends of the flaps is substantially planar.

Furthermore, in accordance with some embodiments of the present invention, the thickness of the flap is less than one millimeter.

Furthermore, in accordance with some embodiments of the present invention, the plurality of projections includes a hierarchical microstructure wherein a plurality of narrower projections extends outward from each of a plurality of wider projections.

Furthermore, in accordance with some embodiments of the present invention, the plurality of wider projections includes a plurality of hexagonal group bases separated from one another by grooves.

Furthermore, in accordance with some embodiments of the present invention, a projection of the plurality of projections includes a columnar projection from whose distal end the flap extends.

Furthermore, in accordance with some embodiments of the present invention, a distal section of the columnar projection is tapered.

Furthermore, in accordance with some embodiments of the present invention, the columnar projection has a substantially rotationally symmetric cross section or has an elongated lateral dimension.

Furthermore, in accordance with some embodiments of the present invention, the flaps that extend from the plurality of projections and that are located in a single region of the microstructure are arranged substantially parallel to one another.

Furthermore, in accordance with some embodiments of the present invention, each of the flaps includes a projecting ridge on one of its lateral sides.

Furthermore, in accordance with some embodiments of the present invention, the projecting ridges on all of the flaps within a single region of the microstructure face a single direction when the flaps are unbent.

Furthermore, in accordance with some embodiments of the present invention, the microstructure includes an elastomer.

There is further provided, in accordance with some embodiments of the present invention, a method for producing an adhesive microstructure, the method including: providing a template that includes a plurality of indentations, each indentation having a shape that complements each of a plurality of projections of the adhesive microstructure to be produced, a distal end of each of the projections including a resilient flap, each of the projections of the microstructure extending from a common substrate in a direction that is substantially perpendicular to a surface defined by distal ends of the flaps when the flaps are unbent, all lateral dimensions of each of the projections increasing monotonically with increased distance from the surface defined by distal ends of the flaps; and filling each of the indentations of the template with a polymerizable material so as to cause the material to polymerize within the indentation.

Furthermore, in accordance with some embodiments of the present invention, a back end of an indentation of the plurality of indentations is open.

Furthermore, in accordance with some embodiments of the present invention, the polymerizable material is polymerizable to form an elastomer.

### BRIEF DESCRIPTION OF THE DRAWINGS

In order to better understand the present invention, and appreciate its practical applications, the following Figures are provided and referenced hereafter. Like components are denoted by like reference numerals.

FIG. 1 shows a columnar projection of an adhesive microstructure in accordance with an embodiment of the present invention;

FIG. 2 shows a wall projection of an adhesive microstructure in accordance with an embodiment of the present invention;

FIG. 3A shows a cross section through a hierarchically arranged adhesive microstructure, in accordance with an embodiment of the present invention;

FIG. 3B shows another cross section through the hierarchically arranged adhesive microstructure shown in FIG. 3A;

FIG. 4 shows a top view of a hierarchical arrangement of microstructure projections in an adhesive microstructure, in accordance with an embodiment of the present invention; and

FIG. 5 schematically illustrates production of an adhesive microstructure in accordance with an embodiment of the present invention.

### DETAILED DESCRIPTION OF THE INVENTION

In accordance with embodiments of the present invention, a surface of a substrate is provided with an adhesive microstructure. The adhesive microstructure is made of flexible material (e.g., an elastomer or rubber-like material) and includes a plurality of projections that extend from a common substrate. A distal end of each projection includes a resilient flap. All lateral dimensions of each of the projections increase monotonically with increased distance from a surface that is defined by distal ends of the flaps when the flaps are unbent. Each of the projections extends from the common substrate in a general direction that is locally substantially perpendicular to the surface defined by the ends of the flaps. The flaps may be placed in contact with a cooperating surface. When a shear force is applied to each of the flaps by relative motion between the flap and the cooperating surface, that flap may bend. Bending of the flap increases an area of contact between the flap and the cooperating surface. Increasing the area of contact increases adhesion and friction between the microstructure and the cooperating surface.

As used herein, an adhesive microstructure refers to an adhesive structure that includes flaps whose dimensions (e.g., thickness, or a length between the distal end of the flap and the end of the projection from which it extends) are small (e.g., less than millimeters, more specifically, less than 100 micrometers, for example, in a range of about 5 micrometers to about 10 micrometers). Other dimensions of the microstructure (e.g., of projections or of bases of projections) may be much larger (e.g., centimeters or meters).

In some embodiments of the present invention, the projections of the adhesive microstructure may be described as projecting or extending outward from the substrate surface in a direction that is locally substantially perpendicular to the substrate surface. As used herein, a direction of extent is described as locally perpendicular to a surface when the direction of extent is perpendicular to a tangent to the surface at a point on the surface where a line that extends along the direction of extent meets the surface.

The projections may be part of a hierarchical structure in which one or a plurality of narrower projections extends outward from each of a plurality of wider projections. In the case of a hierarchical structure, the substrate surface herein refers to the surface of the structure that is most proximal to the substrate.

The substrate surface may represent a flat or curved surface of an object, or a surface of a coating, application, wrapping, or cover that is applied to the surface of the object. The object may be designed or configured to adhere to a cooperating surface that is brought into contact with the adhesive microstructure on the object surface.

A distal end (furthest from the substrate surface) of each projection (or the narrowest projection of a hierarchical structure) ends in a thin flap that extends outward, away from the substrate surface. The flap has a substantially flat shape in which the two opposite broad sides of the flap, herein referred as the lateral sides, are separated from one another by a relatively small thickness of the flap. In the absence of applied forces, the flap is unbent and extends distally outward from the substrate. The flap is sufficiently flexible so as to bend when a shear force is applied to the flap. When the adhesive microstructure is brought into contact with the cooperating surface, a relative shear force between the adhesive microstructure and the cooperating surface may bend the flap. “Shear force or motion” in the context of the present specification refers to a force or motion that has a vector component which is perpendicular to the general orientation of the projection or projections on the adhesive microstructure.

When bent in an appropriate direction, the bending of the flap may cause a lateral side of the flap to come into contact with the cooperating surface, or may increase the area contact between the lateral side and the cooperating surface. An adhesive force between the flap, and thus the object surface that includes the adhesive microstructure, and the cooperating surface (e.g., due to van der Waals forces between the flap and the cooperating surface) may be increased with increasing area of contact. On the other hand, application of a shear force in the reversed direction (e.g., by sliding the object surface relative to the cooperating surface in the reversed direction, or by applying a force to separating the object surface from the cooperating surface) may decrease the adhesive force, enabling detachment of the adhesive microstructure from the cooperating surface.

Each lateral dimension of each projection (including narrower projections that extend from wider projections in a hierarchical structure) may be described as increasing monotonically with increased distance from a surface that is defined by the distal (furthest from the substrate) ends of the flaps when the flaps are unbent. As used herein, a lateral dimension of a projection refers to any dimension that is substantially parallel to the surface that is defined by the distal ends of the flaps when the flaps are unbent. Thus, a lateral dimension is substantially perpendicular to the direction in which the projection extends from the substrate surface. The projections and the substrate, as well as any hierarchical structure, may be formed as a single integral unit. For example, an entire hierarchical structure may be molded out of a polymerizable material using a single molding process.

In some embodiments of the present invention, a substrate surface may be well defined. A substrate surface is well defined when a continuous curve (e.g., straight line, or a curve with substantially constant curvature or a curve whose curvature varies in a regular manner) may be arranged to coincide with all surfaces of the adhesive microstructure that are most proximal to the substrate in a planar slice through the adhesive microstructure. Although the substrate surface is not always well defined and not always parallel to the surface defined by the by the distal ends of the flaps, in much of the following discussion the surfaces are assumed to be at least locally parallel to one another. Thus, in the following discussion, increasing distance away from the substrate surface is used interchangeably with decreasing distance from the surface defined by the by the distal ends of the flaps.

In accordance with embodiments of the present invention, the adhesive structure includes a plurality of columnar projections (representing the narrowest projections in a hierarchical structure). Each columnar projection of the adhesive microstructure includes a column-like projection base that extends substantially perpendicularly from a substrate surface. A flexible thin (e.g., thinner than one millimeter, more specifically, less than 100 micrometers, for example, in the range of about 5 micrometers to about 10 micrometers) flap or film-like structure extends outward (away from the substrate surface) from a distal end of the projection base. The projection base and flexible flap are constructed out of an elastic, or otherwise resilient, flexible, or pliable material.

When the adhesive microstructure is placed against a cooperating surface, a shear movement or force (e.g., having a component which is perpendicular to the general orientation of the projection or projections on the adhesive microstructure) may cause one or more of the flexible flaps to bend. The bending of one of the flexible flaps may bring a portion of one of the lateral surfaces of that flexible flap into contact with the cooperating surface. Increasing bending of the flexible flap may cause the area of contact between the lateral surface of the flexible flap and the cooperating surface to increase. Similar bending of a plurality of flexible flaps of the adhesive microstructure may thus increase the total area of contact between adhesive flaps of the adhesive microstructure and the cooperating surface. Increasing the area of contact between each flap (or the total area of contact between the adhesive microstructure) and the cooperating surface may increase an adhesive force (e.g., resulting at least in part from van der Waals forces) between the adhesive microstructure (and thus the substrate surface) and the surface. The resulting force may be sufficient to reversibly hold an object whose surface includes the adhesive microstructure to a vertical surface (e.g., a wall) or to an overhead (bottom of a horizontal) surface (e.g., a ceiling). Adhesion or an adhesive force as used herein is to be understood as including friction or any other force that resists relative lateral or shearing motion between the adhesive microstructure and the cooperating surface.

On the other hand, moving the adhesive microstructure away from the cooperating surface may cause the flexible flaps to straighten, reducing the area of contact and, thus, the adhesive force. Thus, the substrate that includes the adhesive microstructure is detachable from the cooperating surface.

The contact area unit area of the adhesive microstructure may be sufficient to balance the weight of an object (or other forces tending to detach the object from the surface) that is to be held by the adhesive microstructure to the vertical or overhead surface. For example, when the object is uniformly distributed, the required area may be expressed as a ratio of contact area fraction (e.g., area of contact of the flexible flaps with the cooperating surface, expressed as a fraction of the corresponding area of the object) to mass (or weight) area density of the object (e.g., mass, weight, or other applied force per unit area of the object).

Selection of dimensions of elements of the adhesive microstructure may be constrained in part by, or may be influenced by, properties of the cooperating surface to which the adhesive microstructure is to adhere. For example, a rough or bumpy cooperating surface may require that the size of the projections or flexible flaps be sufficiently small to enable the projections or the flexible flaps to accommodate the roughness. The flexible flap may be made sufficiently thin such that an elastic force that resists bending of the flexible flap (tending to straighten the flexible flap) may be negligible. Thus, the adhesive microstructure may continue to adhere until detached by application of a reversed shear.

The column-like projection base of each columnar projection may enable the adhesive microstructure to accommodate and adhere to a cooperating surface that is not completely flat. For example, the projection base, as is the remainder of the adhesive microstructure, may be made of a flexible material. The projection base of a columnar projection that is placed against a boss, projection, or raised portion of a cooperating surface may be compressed. On the other hand, a projection base of a neighboring columnar projection that is placed against a flat portion of the cooperating surface, or against a depression in the cooperating surface, may remain fully extended.

The column-like projection base of each columnar projection may have a rounded (e.g., circular, elliptical, or oval) cross section, a polygonal (e.g., tetragonal or hexagonal) cross section, or another cross section having rotational symmetry. In accordance with some embodiments of the present invention, a lateral dimension of the projection base may be elongated relative to another lateral dimension, or may be asymmetric.

In accordance with some embodiments of the present invention, the columnar projections may be arranged in a hierarchical arrangement of projection groups. Within each projection group, a plurality of the columnar projections extends outward from a common group base surface. Each group base surface extends outward from the substrate surface. Such a hierarchical arrangement may enable increased flexibility of the substrate with its adhesive microstructure. The increased flexibility may enable increased adhesiveness of the adhesive microstructure to a bent, curved, or otherwise uneven cooperating surface.

The group base surfaces may be shaped so as to enable a dense arrangement or packing of projection groups and columnar projections on the substrate surface. For example, the group base surfaces may be hexagonally shaped. In accordance with some embodiments of the present invention, a further hierarchical organization of a plurality of groups in a larger scale structure (e.g., super-group) is possible.

A distal section of each projection base may be tapered. Tapered is herein understood to include a shape that is domed, rounded, conic, or otherwise shaped so as to decrease in cross section as the distance from the substrate surface increases. Such a tapering may inhibit adhesion of the flexible flap of each columnar projection to its projection base, or decrease the adhesive force between the flexible flap and its projection base in case of such contact.

Some or all of the flexible flaps may be provided with a protruding ridged structure one of the lateral surfaces of the flexible flap. For example, the protruding ridged structure may include one or more elongated protrusions. The elongated dimension of the elongated protrusions may be oriented (when the flexible flap extends perpendicularly outward from the substrate surface) substantially parallel to the direction in which the projection extends out of the substrate surface. The protruding ridged structure may inhibit (or decrease the adhesive force of) adhesion between the flexible flap of one columnar projection of the adhesive microstructure to a flexible flap of a neighboring columnar projection of the adhesive microstructure.

When the flexible flaps are provided with protruding ridged structures, all of the projections in a single region of the adhesive microstructure may be oriented in a single direction relative to one another. Thus, a ridged lateral surface of a flexible flap of one of the columnar projections faces a flat, non-ridged lateral surface of a neighboring columnar projection of the adhesive microstructure.

In a single region of the adhesive microstructure, all of the columnar projections may be oriented in a single direction. In such a region, only a shear motion of the adhesive microstructure in a direction that causes the flat lateral surfaces of the flexible flaps to contact the cooperating surface results in strong adhesion of that region of the adhesive microstructure to the cooperating surface. A shear motion in another direction may result in no adhesion of that region to the cooperating surface, or to a weak adhesive force. In order to enable the adhesive microstructure to provide adhesion with shear motions in more than one direction, the adhesive microstructure may be divided into multiple regions. For example, each region may correspond to one or more neighboring projection groups. The flexible flaps in one of the regions may thus be oriented differently from the flexible flaps in a neighboring region.

An adhesive microstructure in accordance with embodiments of the present invention may enable adhesion under a variety of circumstances. The adhesion may be activated by a shear motion of the adhesive microstructure relative to a cooperating surface to which that adhesive microstructure is to adhere. Such adhesion, being based at least in part on van der Waals forces and not on suction may enable the adhesive microstructure to adhere under circumstances where other structures may not. For example, an adhesive microstructure in accordance with embodiments of the present invention may adhere to a cooperating surface under water, in a vacuum, or outside of the earth's atmosphere. The adhesive microstructure may adhere to a wide variety of materials, including, for example, metal, glass, textile, or paper. The adhesive microstructure may be incorporated into a surface, e.g., of a glove or of a handle, to provide to prevent, inhibit, or reduce slipping of tools or utensils. The adhesive microstructure may be incorporated into a component (e.g., limb) of a robot to enable the robot to climb a wall, to cling to or move along a ceiling, or to securely hold or handle an object. Since adhesion of the adhesive microstructure to the cooperating surface does not result from or entail a chemical reaction between the adhesive microstructure and the cooperating surface, chemical compatibility between the adhesive microstructure and the cooperating surface or a special environment is not required. Also, the absence of a chemical reaction enables the adhesive microstructure to be removed from the cooperating surface without leaving a residue.

Thus, the adhesion of an adhesive microstructure in accordance with embodiments of the present invention to a cooperating surface may be comparable to adhesion of animals such as insects, spiders, or geckoes to cooperating surfaces. The feet of such animals have been found to include spatula-shaped elements that enable the animal to cling to vertical surfaces or the bottom of a horizontal surface.

Adhesion between the adhesive microstructure and the cooperating surface is anisotropic. A shearing force or motion that increases the area of contact between a lateral side of each of a plurality of the elastic flaps and the cooperating surface may increase adhesion. A shearing force in the opposite direction decreases adhesion. On the other hand, a shearing motion that does not affect the area of contact (e.g. substantially parallel to the lateral sides) may not appreciably affect the adhesion. Similarly, a shearing motion that bends the flap so as to causes a ridged lateral side to face the cooperating surface (or a motion in the reverse direction) may also not appreciably affect the adhesion.

In accordance with embodiments of the present invention, each columnar projection, as well as any hierarchical structure that includes the columnar projection, is constructed such that its lateral dimensions (e.g., width, thickness, diameter, radius, or other dimension that is substantially parallel to the substrate surface) monotonically decrease (remain the same or are reduced, but do not increase) with increased distance from the substrate surface. Thus, each projection base is narrower than its group base surface. A proximal (closest to the substrate surface) section of each projection base has either constant lateral dimensions or decreases with distance from the substrate surface. A distal section of the projection base may taper or otherwise reduce one or more of its lateral dimensions with increasing distance from the substrate surface. Finally, the dimensions of the flexible flap that extends distally from the distal end of the projection base are no greater than the corresponding dimensions of the distal section of the projection base from which flexible flap extends.

The monotonic decrease in lateral dimensions of structure of the adhesive microstructure with distance from the substrate surface enables manufacture of an adhesive microstructure in accordance with embodiments of the present invention using standard molding techniques. For example, polymerizing elastomeric substances may be poured into a mold or template. After polymerization is complete, the polymerized elastomer formed into the adhesive microstructure may be peeled off, or otherwise removed, from the mold or template. Suitable polymers include, for example, polydimethylsiloxane (PDMS), polyvinyl siloxane (PVS), or another rubber-like material. (Were the structure to contain elements that widen with distance from the substrate surface, it would not be possible to simply separate the structure from the mold by peeling without risking damage to the polymerized structure. Furthermore, with a structure containing elements that widen with distance from the substrate surface, ensuring that the polymerizing material fills the mold could require application of a vacuum.)

A template for producing the adhesive microstructure could be produced using laser machining techniques. Other techniques could be used to form the template. Such other techniques include, for example, lithography, hot embossing, or other machining techniques. A technique for forming the template may be selected in accordance with the dimensions of the template (and thus of the adhesive microstructure), or the materials used to form the template or the adhesive microstructure.

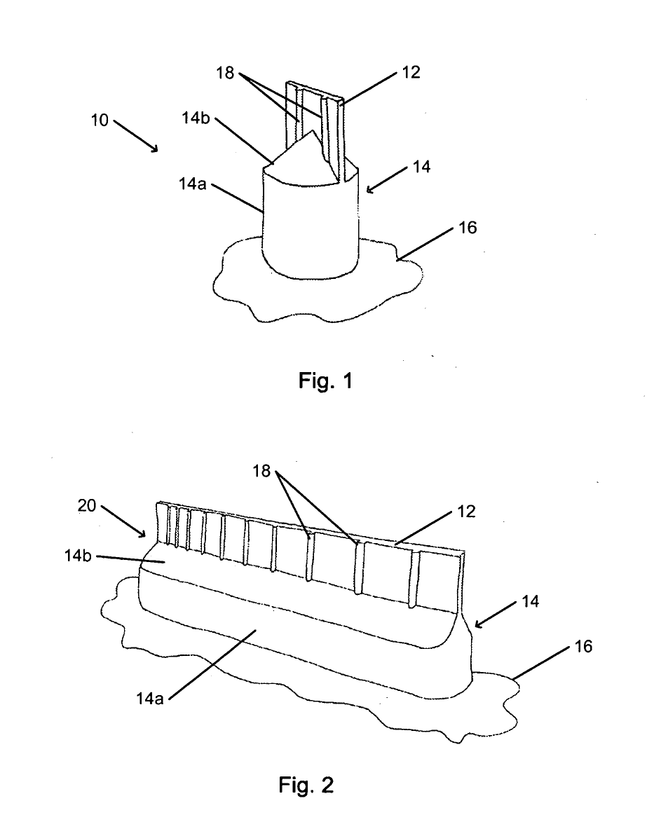

As described above, an adhesive microstructure in accordance with embodiments of the present invention includes an arrangement of flexible columnar projections. FIG. 1 shows a columnar projection of an adhesive microstructure in accordance with an embodiment of the present invention.

Columnar projection 10 extends substantially perpendicularly from base surface 16. Base surface 16 may represent a substrate from which a plurality of projections 10 extends. When the adhesive microstructure of which columnar projection 10 is a component includes a hierarchical arrangement of projection groups, base surface 16 may represent a surface of the group base.

Columnar projection 10 includes a flexible flap 12 that extends from projection base 14. Projection base 14 includes proximal section 14a and distal section 14b. As shown, proximal section 14a of projection base 14 has cross section that remains approximately constant with distance from base surface 16. The cross section of proximal section 14a is shown as approximately circular (axisymmetric). In accordance with other embodiments of the present invention, proximal section 14a may taper slightly, or may be absent (e.g., all of projection base 14 tapering as shown for distal section 14b). The cross section may have another form with rotational symmetry (e.g., polygonal), may have a different symmetry, or may be asymmetric.

Distal section 14b of projection base 14 is shown as tapering with distance from base surface 16. Flexible flap 12 extends distally outward from distal section 14b. The broad sides (as opposed to the narrow ends) of flexible flap 12 are herein referred to as lateral sides of flexible flap 12. In the absence of applied forces, flexible flap 12 extends distally outward as shown (remains unbent). When flexible flap 12 is sheared against a cooperating surface, flexible flap 12 may bend such that one of the lateral sides of flexible flat 12 faces outward, away from base surface 16 and toward the cooperating surface.

As shown, one of the lateral sides of flexible flap 12 may be provided with projecting ridges 18. Projecting ridges 18 extend approximately parallel to the direction in which columnar projection 10 extends (and approximately perpendicular to base surface 16). Projecting ridges 18 provide protruding ridged structure for inhibiting adhesion of a flexible flap 12 of one columnar projection 10 from adhering to a flexible flap 12 of a neighboring columnar projection 10.

In accordance with other embodiments of the present invention, flexible flap 12 does not include projecting ridges 18 such that both lateral sides of flexible flap 12 are flat.

In accordance with embodiments of the present invention, a lateral dimension (approximately parallel to base surface 16) of a projection of an adhesive microstructure is elongated relative to another lateral dimension of the projection. FIG. 2 shows an elongated variant of the columnar projection shown in FIG. 1.

Elongated columnar projection 20 is elongated along one of its lateral dimensions. As shown, the taper of distal section 14b of projection base 14 is limited to the direction that is approximately perpendicular to the elongated dimension of elongated columnar projection 20. In accordance with other embodiments of the present invention, the taper may be in both lateral dimensions.

Flexible flap 12 of elongated columnar projection 20 is shown as arranged parallel to the elongated dimension of elongated columnar projection 20. Flexible flap 12 is shown as provided with multiple (more than two) of projecting ridges 18.

In accordance with some embodiments of the present invention, elongated columnar projection 20 may be provided with multiple flexible flaps that are each oriented approximately perpendicular to the elongated dimension of elongated columnar projection 20.

Although elongated columnar projection 20 is shown as having a rounded cross section, the cross section of elongated columnar projection 20 may be polygonal (e.g., tetragonal). In accordance with some embodiments of the present invention, a length of elongated columnar projection 20 along the elongated dimension may be much larger than other typical dimensions. For example, the length along the elongated dimension may range from micrometers to meters.

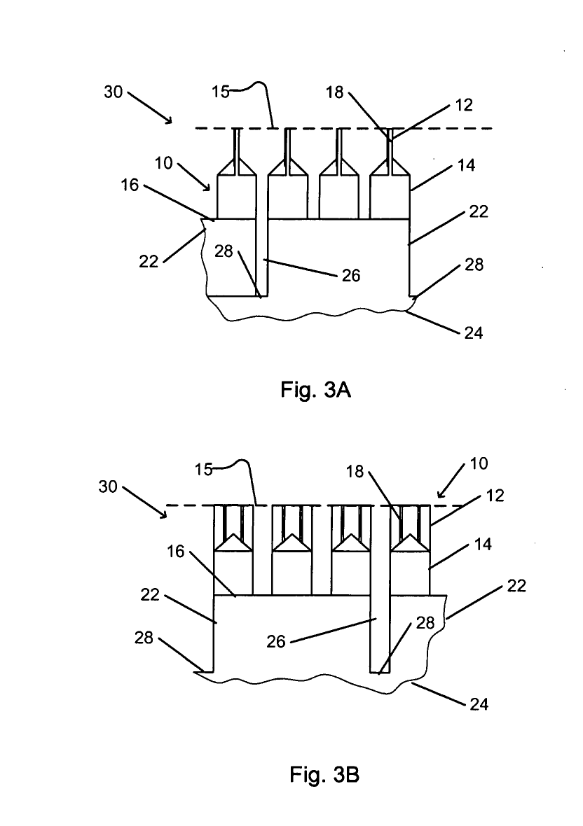

In accordance with some embodiments of the present invention, microstructure projections may be arranged in a hierarchical structure. FIG. 3A shows a cross section through a hierarchically arranged adhesive microstructure, in accordance with an embodiment of the present invention. FIG. 3B shows another cross section through a hierarchically arranged adhesive microstructure, in accordance with an embodiment of the present invention.

Hierarchical adhesive microstructure 30 includes a plurality of hierarchically arranged columnar projections 10. Each columnar projection 10 extends from a group base 22. A plurality of columnar projections 10 extend from each group base 22.

A plurality of group bases 22 extends from substrate surface 28 of substrate 24. Adjacent group bases 22 are separated from one another by a groove 26. The grooved hierarchical arrangement may enable hierarchical adhesive microstructure 30 to bend more easily than would be possible in the absence of grooves 26.

In some embodiments of the present invention, a substrate surface may not be well defined. For example, the bottom of a groove 26 may not be planar (e.g., is curved or continuously narrowing). In other embodiments, the bottom surfaces of grooves 26 may be sloped or stepped, or have different heights.

Flap end surface 15 is defined by (and passes through) the distal ends of flexible flaps 12. As shown, flap end surface 15 is substantially planar. In other cases, e.g., when adhesive microstructure 30 is curved, flap end surface 15 may be curved.

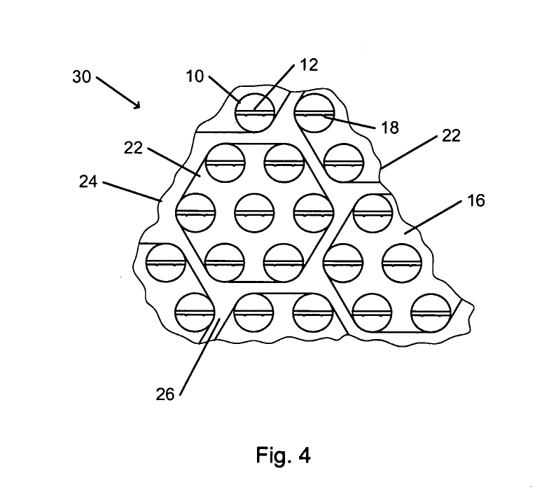

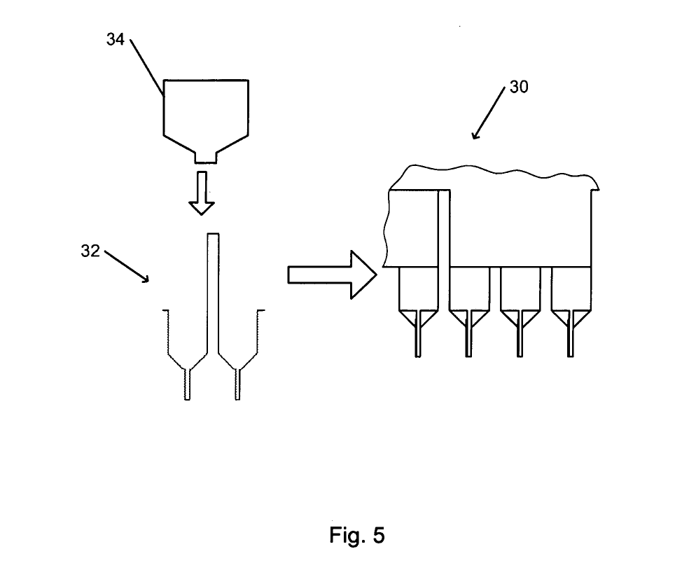

A two-dimensional arrangement of group bases 22 may enable dense packing of group bases 22, and thus of columnar projections 10. FIG. 4 shows a top view of a hierarchical arrangement of microstructure projections in an adhesive microstructure, in accordance with an embodiment of the present invention. As shown, each group base 22 has a hexagonal shape. Such a hexagonal shape may enable dense two-dimensional packing of group bases 22 while enabling bending flexibility of hierarchical adhesive microstructure 30.

As shown, all flexible flaps 12 of columnar projections 10 are arranged parallel to one another. Projecting ridges 18 on each of flexible flaps 12 in the region of hierarchical adhesive microstructure 30 that is shown are each located on a lateral side of its flexible flap 12 that faces a single direction (toward the bottom of FIG. 4).

In accordance with other embodiments of the present invention, flexible flaps 12 of columnar projections 10 that extend from different group bases 22 may be arranged with different orientations.

In accordance with some embodiments of the present invention, some components of hierarchical adhesive microstructure 30 may be partially hollow. Components that may be partially hollow may include, for example, substrate 24, group bases 22, or projection bases 14. The lateral dimensions of any hollow or cavity in the components also monotonically decrease with distance from substrate 24.

Lateral dimensions of all components of hierarchical adhesive microstructure 30, of group bases 22, of columnar projections 10, of projection bases 14, and of flexible flaps 12 (including projecting ridges 18) monotonically decrease with distance from substrate surface 28 (FIGS. 3A and 3B) of substrate 24. Thus, a hierarchical adhesive microstructure 30 may be manufactured by molding in an appropriate mold or template.

In accordance with some embodiments of the present invention, some components of hierarchical adhesive microstructure 30 may be partially hollow. Components that may be partially hollow may include, for example, substrate 24, group bases 22, or projection bases 14. The lateral dimensions of any hollow or cavity in the components also monotonically decrease with distance from substrate 24.

A method for producing an adhesive structure may include filling indentations of a template with a polymerizable material, polymerizing the material, and removing the polymerized material from the template. FIG. 5 schematically illustrates production of an adhesive microstructure in accordance with an embodiment of the present invention.

A template 32 may be provided in the form of a shape that is complementary to the shape of hierarchical adhesive microstructure 30. Two shapes are herein considered complementary when each projection of one of the shapes may be inserted into, or complement, a corresponding indentation of the other of the shapes so as to substantially fill the indentation. Thus, template 32 is provided with a plurality of indentations that each complement a corresponding projection of hierarchical adhesive microstructure 30.

The back end of an indentation (the narrowest end of the indentation, facing away from the end of the indentation through which that indentation is filled with polymerizable material) may be closed or may be open. An opening (e.g., a slot or hole) at the back end of the indentation may facilitate filling of the indentation with the polymerizable material. Since the opening opens the back end of the indentation to the ambient atmosphere, the opening may prevent trapping of air in the indentation when the indentation is filled. On the other hand, when filling an indentation whose back end is closed, additional measures may be required to prevent or inhibit trapping or air. For example, when the backs of the indentations are closed, the indentations may be filled under vacuum conditions, or additional measures may be taken to remove trapped air or air bubbles from the filled indentations.

For example, template 32 may represent a thick piece (e.g., of metal, ceramic, glass, or similar material) that had been machined (e.g., by laser machining) to have the appropriate complementary shape. As another example, template 32 may represent a thin sheet (e.g., of metal) that had been shaped by embossing or stamping to have the appropriate shape.

Template 32 may be filled with polymerizable material 34. For example, polymerizable material 34 may represent one or more polymerizing elastomeric substances. After template 32 is filled with polymerizable material 34, polymerizable material 34 is polymerized.

In accordance with some embodiments of the present invention, various elements (e.g., substrate 24, group bases 22, columnar projections 10, projection bases 14, or flexible flaps 12, as shown, e.g., in FIGS. 3A and 3B) of hierarchical adhesive microstructure 30 may be formed from different materials. In such a case, indentations of template 32 may be filled to a level that corresponds to one of the elements of hierarchical adhesive microstructure 30 by a first polymerizable material 34. The indentations of template 32 may continue to be filled (either prior to, after, or during polymerization of the first polymerizable material 34) to a level that corresponds to another element of hierarchical adhesive microstructure 30 by a second, different polymerizable material 34.

In accordance with some embodiments of the present invention, a cavity in a component of hierarchical adhesive microstructure 30 may be formed by insertion of an appropriate form (not shown) into template 32 after template 32 is filled with polymerizable material 34 and prior to polymerization. For example, such a form may include projections, each projection having a shape that is complementary to the cavity to be formed.

Once polymerizable material 34 is polymerized in template 32, the polymerized material (e.g., an elastomer) may be removed from template 32. The removed polymerized material may be in the form of hierarchical adhesive microstructure 30, or of a similar structure.

For example, a template may be formed from a thin (150 μm to 200 μm) sheet. The back (narrowest) ends of the indentations in the template include slots. For example, the slots may be cut through the thin sheet using a laser. The polymerizable material is poured into (each indentation) of the template from the front of side of the template (the side where the indentations are widest—the side opposite the side with the slots). The material polymerizes prior to reaching the back end of each indentation.

In accordance with embodiments of the present invention, other methods for shaping an elastic substrate may be applied to produce an adhesive microstructure or a hierarchical adhesive microstructure.

1. A microstructure made of flexible material and comprising a plurality of projections extending from a common substrate, a distal end of each projection including a resilient flap, wherein all lateral dimensions of each of the projections increase monotonically with increased distance from a surface defined by distal ends of the flaps when the flaps are unbent, and wherein each of the projections extends from the common substrate in a general direction that is locally substantially perpendicular to the surface defined by the ends of the flaps, such that when a shear force is applied to each of the flaps by relative motion between that flap and a cooperating surface in contact with that flap, that flap bends so as to increase the area of contact of that flap with the cooperating surface and to affect adhesion between the microstructure and the cooperating surface.

2. The microstructure of claim 1, wherein, the surface defined by the ends of the flaps is substantially planar.

3. The microstructure of claim 2, wherein the thickness of the flap is less than one millimeter.

4. The microstructure of claim 1, wherein said plurality of projections includes a hierarchical microstructure wherein a plurality of narrower projections extends outward from each of a plurality of wider projections.

5. The microstructure of claim 4, wherein the plurality of wider projections comprises a plurality of hexagonal group bases separated from one another by grooves.

6. The microstructure of claim 1, wherein a projection of said plurality of projections comprises a columnar projection from whose distal end the flap extends.

7. The microstructure of claim 6, wherein a distal section of the columnar projection is tapered.

8. The microstructure of claim 6, wherein the columnar projection has a substantially rotationally symmetric cross section or has an elongated lateral dimension.

9. The microstructure of claim 1, wherein the flaps that extend from said plurality of projections and that are located in a single region of the microstructure are arranged substantially parallel to one another.

10. The microstructure of claim 1, wherein each of the flaps includes a projecting ridge on one of its lateral sides.

11. The microstructure of claim 10, wherein the projecting ridges on all of the flaps within a single region of the microstructure face a single direction when the flaps are unbent.

12. The microstructure of claim 1, the microstructure comprises an elastomer.

13. A method for producing an adhesive microstructure, the method comprising:
providing a template that includes a plurality of indentations, each indentation having a shape that complements each of a plurality of projections of the adhesive microstructure to be produced, a distal end of each of the projections including a resilient flap, each of the projections of the microstructure extending from a common substrate in a direction that is substantially perpendicular to a surface defined by distal ends of the flaps when the flaps are unbent, all lateral dimensions of each of the projections increasing monotonically with increased distance from the surface defined by distal ends of the flaps; and
filling each of the indentations of the template with a polymerizable material so as to cause the material to polymerize within the indentation.

14. The method of claim 13, wherein a back end of an indentation of said plurality of indentations is open.

15. The method of claim 13, wherein the polymerizable material is polymerizable to form an elastomer.
